(19) United States
(12) Patent Application Publication
(10) Pub. No.: US 2024/0152345 A1
(43) Pub. Date: May 9, 2024

(54) SYSTEM FOR DETERMINING A REPRESENTATIVE VEHICLE SOFTWARE CONFIGURATION FOR ANALYSIS

(71) Applicant: GM Global Technology Operations LLC, Detroit, MI (US)

(72) Inventors: Arun Adiththan, Sterling Heights, MI (US); Prakash Mohan Peranandam, Rochester Hills, MI (US); Ramesh Sethu, Troy, MI (US); Joseph G. D'Ambrosio, Clarkston, MI (US); Muralikrishnan Kailasam, Troy, MI (US); Sitaram Emani, South Lyon, MI (US)

(21) Appl. No.: 18/053,495

(22) Filed: Nov. 8, 2022

(51) Int. Cl. G06F 8/65; G06F 9/445; G07C 5/08

(52) U.S. Cl. CPC G06F 8/65; G06F 9/44505; G07C 5/08

(57) ABSTRACT

A system for determining a representative vehicle software configuration for a subset vehicles that are part of a group of vehicles. The system includes one or more processors and a memory coupled to the one or more processors, where the memory stores data comprising a database and program code that, when executed by the one or more processors, causes the system to select a module configuration that is part of a set of combined module configurations as the representative vehicle software configuration based on at least one predefined criteria.

### INTRODUCTION

The present disclosure relates to a system for determining a representative vehicle software configuration for a subset of vehicles, where the subset of vehicles is part of a group of vehicles.

A vehicle configuration refers to the type of driveline, vehicle class, software features, functionalities, and type of powertrain that a vehicle may include. Specifically, the driveline configuration indicates if a vehicle includes all-wheel-drive, front wheel drive, rear wheel drive, or four wheel drive. The vehicle class indicates if a vehicle is sedan, truck, or a sport utility vehicle, and the powertrain configuration indicates if a vehicle includes a spark ignition engine, a compression ignition engine, or an electric motor. In addition to the vehicle configuration, vehicles may vary based on the specific optional features offered. For example, a vehicle may include optional features such as auto-park assist and electric power steering (EPS).

A vehicle includes multiple electronic control units (ECUs) that are each responsible for controlling a specific system or subsystem that is part of the vehicle. For example, a vehicle that offers auto-park assist would include an auto-park ECU. Accordingly, an increase in the number of optional features results in an additional number of ECUs that are included in a vehicle. For example, a luxury vehicle, which typically offers many optional features, may include fifty or more ECUs. In contrast, a base model vehicle, which typically offers fewer optional features, may include significantly fewer ECUs. Furthermore, it is to be appreciated that vehicles of the same model may include different vehicle configurations as well as offer different optional features. Thus, the overall number of ECUs may vary even between vehicles of the same model.

An ECU includes a set of software components, where multiple versions of a particular software component may exist. Some examples of software components for an ECU include sensor and actuator software components, application software components, operational software components, calibration software components, and utility software components. An ECU software configuration includes unique combinations of versions of the software components, and a combination of all such ECU software configurations form a vehicle software configuration. As mentioned above, vehicles of the same model may include different vehicle configurations as well as offer different optional features. Thus, vehicles of the same model and having the same features that are manufactured at different points in time may still have many different vehicle software configurations, especially since software component versions evolve over time. Accordingly, since there are a vast number of different vehicle software configurations that exist between vehicles, it may be challenging to determine an effective representative vehicle software configuration for software validation purposes.

Thus, while current systems achieve their intended purpose, there is a need in the art for an improved approach to determine a representative vehicle software configuration for software validation purposes.

### SUMMARY

According to several aspects, a system for determining a representative vehicle software configuration for a subset vehicles that are part of a group of vehicles is disclosed. The system includes one or more processors and a memory coupled to the one or more processors, the memory storing data comprising a database and program code that, when executed by the one or more processors, causes the system to assign a dependency level to each electronic control unit (ECU) for each vehicle that is part of the group of vehicles. The system assigns, based on the dependency level, a respective weight value to each ECU for each vehicle that is part of the group. The system determines a cluster distance measured between two respective module configurations corresponding to two vehicles that are part of the group based on respective weight values assigned to the each of the ECUs of the two vehicles, where the cluster distance is determined between the module configurations for each vehicle that is part of the group. The system combines the two respective module configurations together with another based on at least the cluster distance measured between the two respective module configurations to establish a set of combined module configurations. The system selects a module configuration that is part of the set of combined module configurations as the representative vehicle software configuration based on at least one predefined criteria.

In an aspect, the one or more processors execute instructions to determine one or more target ECUs that a software update is applied to based on field update details for each vehicle that is part of the group of vehicles.

In another aspect, the one or more processors execute instructions to determine one or more dependent ECUs based on the one or more target ECUs and one or more system level configuration files, where the system level configuration files indicate the one or more dependent ECUs that are affected by the software update applied to the one or more target ECUs.

In yet another aspect, the respective weight value ranges from zero to one, wherein a highest respective weight value is assigned to the one or more target ECUs, and lower respective weight values are assigned to the one or more dependent ECUs.

In an aspect, the one or more processors execute instructions to adjust the respective weight value assigned to a specific ECU based on a type of change that the software update introduces to the one or more target ECUs, where the type of change that the software update introduces is selected from one of the following: a data type change, a value range change, and a calculation logic change.

In another aspect, in response to determining the type of change that the software update introduces is either the data type change or a value range change, the one or more processors adjust the respective weight value to a highest value assigned to a range of respective weight values.

In yet another aspect, in response to determining the type of change the software update introduces is a calculation logic change, the one or more processors adjust the respective weight value to a lowest value assigned to a range of respective weight values.

In an aspect, a module configuration indicates a number of total ECUs for a particular vehicle, a number of target ECUs for the particular vehicle, and a number of dependent ECUs for the particular vehicle.

In another aspect, the cluster distance between the two respective module configurations is calculated based on:

cluster distance(configi,configj)=(w1*TEC_{i∩j})+(w2*DEC_{i∩j})+(w3*REC_{i∩j})/(w1*TEC_{i∪j})+(w2*DEC_{i∪j})+(w3*REC_{i∪j})

where TEC represents the number of target ECUs for the particular vehicle, DEC represents the number of dependent ECUs for the particular vehicle, REC represents a number of remaining ECUs for the particular vehicle, i and j represent the two vehicles, w1 is the respective weight value assigned to the one or more target ECUs, w2 is the respective weight value assigned to the set of dependent ECUs, and w3 is the respective weight assigned to the remaining ECUs.

In yet another aspect, combining at least two of the respective module configurations together with another comprises comparing the two respective module configurations with a set of mutually exclusive constraints to confirm that the two respective module configurations are combinable, and in response to confirming the two respective module configurations are combinable, comparing the cluster distance measured between the two respective module configurations with a cluster distance threshold value.

In an aspect, combining at least two of the module configurations together with another comprises in response to determining the cluster distance is equal to or greater than the cluster distance threshold value, comparing the two respective module configurations with one another to determine a difference in configuration for the two respective module configurations between the one or more target ECUs and the one or more dependent ECUs. In response to determining no differences exist between the one or more target ECUs and the one or more dependent ECUs between the two module configurations, merge the two respective module configurations together.

In another aspect, the respective weight values range from zero to one.

In yet another aspect, a highest respective weight value is assigned to the one or more target ECUs and a lower respective weight value is assigned to the one or more dependent ECUs.

In an aspect, the predefined criteria represent one or more of the following: a number of overall software components included by a combined module configuration, an overall volume of the combined module configuration, and a level of communication affected by the one or more target ECUs and the dependent ECUs.

In an aspect, a system for determining a representative vehicle software configuration for a subset vehicles that are part of a group of vehicles is disclosed. The system includes one or more processors, and a memory coupled to the one or more processors. The memory stores data comprising a database and program code that, when executed by the one or more processors, causes the system to determine one or more target ECUs that a software update is applied to based on field update details for each vehicle that is part of the group of vehicles. The system determines one or more dependent ECUs based on the one or more target ECUs and one or more system level configuration files, where the system level configuration files indicate the one or more dependent ECUs that are affected by the software update applied to the one or more target ECUs. The system assigns a dependency level to each ECU for each vehicle that is part of the group of vehicles. The system assigns, based on the dependency level, a respective weight value to each ECU for each vehicle that is part of the group, where a highest respective weight value is assigned to the one or more target ECUs, and lower respective weight values are assigned to the one or more dependent ECUs. The system determines a cluster distance measured between two respective module configurations corresponding to two vehicles that are part of the group based on respective weight values assigned to the each of the ECUs of the two vehicles, where the cluster distance is determined between the respective module configurations for each vehicle that is part of the group. The system combines the two respective module configurations together with another based on at least the cluster distance measured between the two respective module configurations to establish a set of combined module configurations. Finally, the system selects a module configuration that is part of the set of combined module configurations as the representative vehicle software configuration based on at least one predefined criteria.

In another aspect, the one or more processors execute instructions to adjust the respective weight value assigned to a specific ECU based on a type of change that the software update introduces to the one or more target ECUs, where the type of change that the software update introduces is selected from one of the following: a data type change, a value range change, and a calculation logic change.

In another aspect, in response to determining the type of change that the software update introduces is either the data type change or a value range change, the one or more processors adjust the respective weight value to a highest value assigned to a range of respective weight values.

In yet another aspect, the one or more processors execute instructions to in response to determining the type of change the software update introduces is a calculation logic change, adjust the respective weight value to a lowest value assigned to a range of respective weight values.

In an aspect, the module configuration indicates a number of total ECUs for a particular vehicle, a number of target ECUs for the particular vehicle, and a number of dependent ECUs for the particular vehicle.

In an aspect, a method for determining a representative vehicle software configuration for a subset vehicles that are part of a group of vehicles is disclosed. The method includes assigning, by a computing device, a dependency level to each electronic control unit (ECU) for each vehicle that is part of the group of vehicles. The method includes assigning based on the dependency level, a respective weight value to each ECU for each vehicle that is part of the group. The method includes determining a cluster distance measured between two respective module configurations corresponding to two vehicles that are part of the group based on respective weight values assigned to the each of the ECUs of the two vehicles, where the cluster distance is determined between the two respective module configurations for each vehicle that is part of the group. The method includes combining, by the computing device, the two respective module configurations together with another based on at least the cluster distance measured between the two respective module configurations to establish a set of combined module configurations. The method includes selecting one of the module configurations that are part of the set of combined module configurations as the representative vehicle software configuration based on at least one predefined criteria.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of the disclosed system for determining a representative vehicle software configuration for a subset of vehicles that are part of a group of vehicles, where the system includes a computing system, according to an exemplary embodiment;

FIG. 2 is a diagram illustrating a unique vehicle software configuration for a vehicle having a plurality of electronic control units (ECUs), according to an exemplary embodiment;

FIG. 3 is a diagram illustrating a cluster distance calculated between two different module configurations for two different vehicles, according to an exemplary embodiment; and

FIG. 4 is a process flow diagram illustrating a method for determining the representative vehicle software configuration for the subset of vehicles, according to an exemplary embodiment.

### DETAILED DESCRIPTION

The following description is merely exemplary in nature and is not intended to limit the present disclosure, application, or uses.

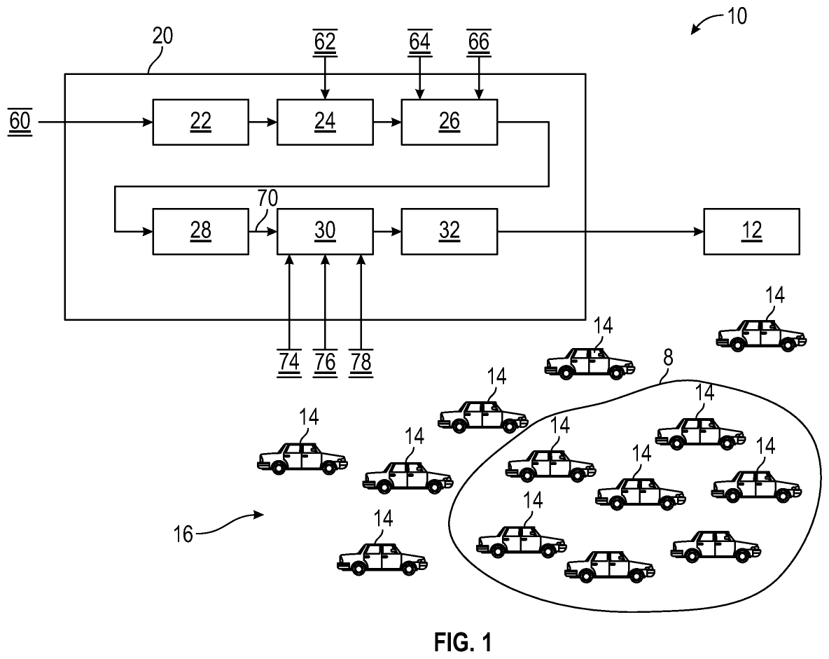

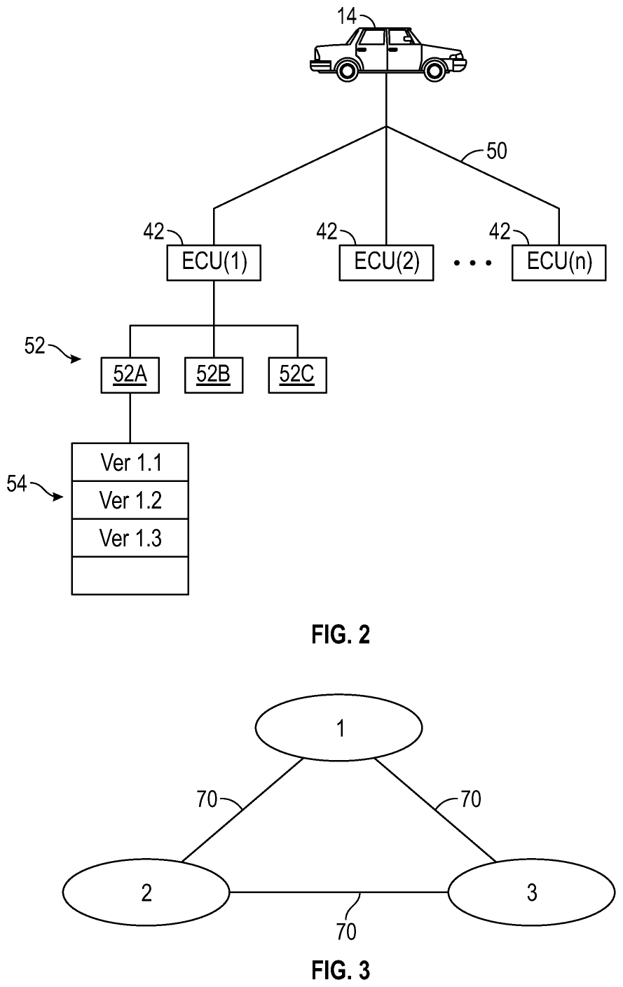

Referring to FIG. 1, an exemplary system 10 for determining a surrogate or representative vehicle software configuration 12 for a subset 8 of vehicles 14 for analysis is illustrated. The subset 8 of vehicles 14 represent a portion of all available vehicles 14 in the field that are part of a group 16. The vehicles 14 may be any type of vehicle such as, but not limited to, a sedan, truck, sport utility vehicle, van, or motor home with different software features. The system 10 includes a computing system 20 that determines the representative vehicle software configuration 12. The computing system 20 includes an identifier module 22, a target module 24, a matrix building module 26, a distance module 28, a cluster module 30, and a determination module 32. Each vehicle 14 that is part of the group 16 of vehicles 14 is associated with a unique vehicle software configuration 50, which is illustrated in FIG. 2.

Referring now to FIG. 2, each vehicle 14 includes a plurality of electronic control units (ECUs) 42. Each ECU 42 is responsible for controlling a particular system or subsystem that is part of the vehicle 14. Some examples of the ECUs 42 include, but are not limited to, an automatic park assist (APA) module, an electric power steering (EPS) module, an infotainment module (ICM), and an electronic brake control module (EBCM). Each ECU 42 includes one or more software components 52. Some examples of the software components 52 include, but are not limited to, sensor and actuator software components, application software components, operational software components, calibration software components, and utility software components. Each software component 52 includes one or more versions that are referred to as parts 54. For example, the software component 52A includes three different parts 54, where each part 54 is associated with a unique version of the software component 52A.

Referring to FIGS. 1 and 2, it is to be appreciated that each version or part 54 of a software component 52 for a particular ECU 42 may represent a software update. When a software update is implemented, the software update is applied to one or more target ECUs 42 that are part of a vehicle 14. Although the software update is applied only to the target ECUs 42 in a vehicle 14, it is to be appreciated that the software update may affect the functionality of one or more dependent ECUs 42 that are part of the vehicle 14. The software update includes at least one updated part 54 corresponding to one of the software components 52. For example, a software update may include new version 1.3 to the software component 52A (FIG. 2). As explained below, the disclosed system 10 determines a representative vehicle software configuration 12 for the subset 8 of vehicles 14 for a given software update, where the representative vehicle software configuration 12 is applicable to all of the vehicles 14 that are part of the subset 8 of vehicles 14. In other words, the representative vehicle configuration 12 is applicable only to a portion of the group 16 of vehicles 14.

It is to be appreciated that while FIG. 2 illustrates the vehicle software configuration 50 for a specific vehicle 14 implemented as physical ECUs, it is to be appreciated that the vehicle software configuration 50 is not limited to physical ECUs, and may be implemented as software as well. For example, in another embodiment, the disclosed system 10 may determine a representative vehicle software configuration 12 for a software-defined vehicle that manages functionality primarily or entirely through software in a centralized or zonal compute platform architecture.

Referring to FIG. 1, the identifier module 22 of the computing system 20 receives field update details 60 as input. The identifier module 22 determines, based on the field update details 60, the one or more target ECUs 42 that the software update is applied to. The field update details 60 indicate an identity of the one or more target ECUs 42 that are modified by the software update. For example, if the software update is for the enhancement of power steering, then the one or more target ECUs 42 would include the EPS module. The identifier module 22 then sends the one or more target ECUs 42 to the target module 24.

The target module 24 receives an identity of the one or more target ECUs 42 and one or more system level configuration files 62 as input. The system level configuration files 62 establish software architecture for the ECUs 42. The system level configuration files 62 indicate one or more dependent ECUs 42, where functionality of the one or more dependent ECUs 42 is affected by the software update applied to the one or more target ECUs 42. For example, a software update applied to the EPS module may affect the APA and the EBCM modules. The target module 24 then determines the set of dependent ECUs 42 based on the one or more target ECUs 42 and the one or more system level configuration files 62. It is to be appreciated that a remaining portion of the ECUs 42 that are part of a specific vehicle 14 that are not the target ECUs 42 or the dependent ECUs 42 may be referred to as the remaining ECUs 42.

The matrix building module 26 obtains and extracts deeper insight with the one or more dependent ECUs 42, and receives an identity of the one or more target ECUs 42 and the one or more dependent ECUs 42 from the target module 24. As seen in FIG. 1, the matrix building module 26 also receives a set of interaction unwinding steps 64 and importance factors 66 as input. The interaction unwinding steps 64 indicate a number of interaction dependency levels that a user analyzes with respect to the dependent ECUs 42, and the importance factors 66 indicate how a respective weight value is assigned to the specific ECU 42 based on a dependency level of the specific ECU 42 relative to the one or more target ECUs 42. The matrix building module 26 assigns a dependency level to each of the one or more dependent ECUs 42 for each vehicle 14 that is part of the group 16 of vehicles 14 based on any number of approaches such as, for example, logic cone analysis. Specifically, a direct or first level of dependency that includes the one or more target ECUs 42. A second level of dependency is assigned to a dependent ECU 42 whose functionality is affected by the one or more target ECUs 42. It is to be appreciated that although only two dependency levels are described, the matrix building module 26 may assign any number of dependency levels to the ECUs 42, where the number of dependency levels are indicated by the interaction unwinding steps 64.

The matrix building module 26 assigns, based on the dependency level, a respective weight value for each ECU 42 for each vehicle 14 that is part of the group 16 of vehicles 14. The respective weight value ranges from zero to one, where the highest respective weight value is assigned to the one or more target ECUs 42, and lower respective weight values are assigned to the one or more dependent ECUs 42. In an embodiment, each dependency level is associated with a range of respective weight values. For example, if the interaction unwinding steps 64 indicate three levels of dependency, then the range of respective weight values may range from 0.7 to 0.9 for the first level of dependency, 0.4 to 0.6 for the second level of dependency, and 0.1 to 0.3 for a third level of dependency. In another example, the interaction unwinding steps 64 indicate two levels of dependency, and the range of respective weight values may range from 0.6 to 0.9 for the first level of dependency and 0.1 to 0.5 for the second level of dependency, and a respective weight value of 1 is assigned to the target ECUs 42.

In an embodiment, the matrix building module 26 adjusts the respective weight value assigned to a specific ECU 42 based on a type of change that the software update introduces to the one or more target ECUs 42. In an embodiment, the type of change that the software update introduces is a data type change, a value range change, or a calculation logic change. In response to determining the type of change that the software update introduces is a data type change or a value range change, the matrix building module 26 adjusts the respective weight value to the highest value assigned to the range of respective weight values. For example, if there are three levels of dependency and the specific ECU 42 is assigned to the first dependency level, then the matrix building module 26 adjusts the respective weight value to 0.9. In response to determining the type of change the software update introduces is a calculation logic change, then the matrix building module 26 adjusts the respective weight value to the lowest value assigned to the range of respective weight values. In the present example, there are three levels of dependency and the specific ECU 42 is assigned to the first dependency level. Therefore, the matrix building module 26 adjusts the respective weight value to 0.7.

The matrix building module 26 sends the respective weight values for the ECUs 42 corresponding to each vehicle 14 of the group of vehicles 14 to the distance module 28. Referring to FIGS. 1 and 2, each vehicle 14 is associated with a unique or module configuration in terms of ECUs 42 or software components. In the present example, the module configuration indicates a number of total ECUs 42 for a particular vehicle 14, a number of target ECUs 42 for the particular vehicle 14, and a number of dependent ECUs for the particular vehicle 14. As explained below, the distance module 28 determines a configuration distance, which is referred to as a cluster distance 70 and is shown in FIG. 3. As seen in FIG. 3, the cluster distance 70 is measured between two respective module configurations, where the module configurations are labelled as 1, 2, and 3. A configuration may represent a cluster of vehicles 14, therefore the distance between two respective module configurations is referred to as a cluster distance. The respective module configurations correspond to a unique vehicle 14 that is part of the group 16 of vehicles 14 shown in FIG. 1. The cluster distance 70 represents a level of similarity between the two respective module configurations.

Referring to FIGS. 1 and 3, the cluster distance 70 measured between two respective module configurations is determined based on the respective weight values assigned to each of the ECUs 42 of the two different vehicles 14. Specifically, in an embodiment, the cluster distance 70 between the two respective module configurations is calculated based on the following equation:

cluster distance(configi,configj)=(w1*TEC_{i∩j})+(w2*DEC_{i∩j})+(w3*REC_{i∩j})/(w1*TEC_{i∪j})+(w2*DEC_{i∪j})+(w3*REC_{i∪j})

where TEC represents the number of target ECUs for the particular vehicle 14, DEC represents the number of dependent ECUs for the particular vehicle 14, REC represents a number of remaining ECUs for the particular vehicle 14, i and j represent the two different vehicles 14, w1 is the respective weight value assigned to the one or more target ECUs 42, w2 is the respective weight value assigned to the one or more of dependent ECUs 42, and w3 is the respective weight assigned to the remaining ECUs 42.

The distance module 28 then sends the cluster distance 70 (FIG. 3) measured between the two respective module configurations to the cluster module 30. The cluster module 30 also receives a cluster distance threshold value 74, a set of merging constraints 76, and a set of mutually exclusive constraints 78 as input. As explained below, the cluster module 30 combines the two respective module configurations together with another based on the cluster distance 70 measured between the two module configurations, the cluster distance threshold value 74, the set of merging constraints 76, and the set of mutually exclusive constraints 78.

The cluster distance threshold value 74 represents a threshold distance measured between two respective module configurations indicating the two respective module configurations are combinable. When the cluster distance 70 (FIG. 3) measured between the two respective module configurations is equal to or greater than the cluster distance threshold value 74, the distance module 28 may combine the two respective module configurations together. It is to be appreciated that the cluster distance threshold value 74 ranges from zero to one and depends on a level of merging that is required between respective cluster distances 70 for the group 16 of vehicle 14. Specifically, the cluster distance threshold value 74 is increased to create a decrease in the level of merging between the respective cluster distances 70 for the group of vehicles 14, and is decreased to create a increase in the level of merging between the respective cluster distances 70 for the group of vehicles 14. For example, if there are many different module configurations associated with the group 16 of vehicles 14, then the cluster distance threshold value 74 may be set to 0.6 or 0.7 to reduce the number of module configurations, however, in another embodiment the cluster distance threshold value 74 may be set to 0.9 if there are fewer module configurations. The cluster distance threshold value 74 may also be adjusted based on a type of analysis required, where a more detailed analysis results in a higher cluster distance threshold value 74.

The set of merging constraints 76 indicate one or more merging criteria for combining the two respective module configurations together. For example, one merging criteria for combining the two respective module configurations together would be overall vehicle volume in a cluster, where a module configuration having a higher overall volume is given priority. Another example of a merging criteria is a total number of software components or parts 54 (FIG. 2) that a module configuration includes, where a module configuration having a higher total number of parts 54 is given priority. In still another example, the merging criteria is a priority level, where module configurations including specific vehicle features are given priority, where the specific vehicle features that are given priority depend upon the specific software version. The set of mutually exclusive constraints 78 indicate when two module configurations are mutually exclusive to one another, and therefore are incapable of being combined with one another. For example, two module configurations are mutually exclusive when one of the vehicles 14 includes an ECU 42 for controlling an automatic transmission and the remaining vehicle 14 includes an ECU 42 for controlling a manual transmission.

The cluster module 30 combines at least one of the module configurations together with another module configuration for the group 16 of vehicles 14 by comparing the module configurations for the two different vehicles 14 with the set of mutually exclusive constraints 78 to confirm the two respective module configurations are combinable. In response to determining the two respective module configurations are combinable, the cluster module 30 then compares the cluster distance 70 measured between the two respective module configurations with the cluster distance threshold value 74.

In response to determining the cluster distance 70 is equal to or greater than the cluster distance threshold value 74, the cluster module 30 then compares the two respective module configurations with one another, and determines if a difference in configuration in exists between the two respective module configurations for the one or more target ECUs 42 and the one or more dependent ECUs 42. The difference in configuration refers to a difference between the two respective configurations with respect to a number of target ECUs 42 and dependent ECUs 42, a number of software components 52, or a number of parts 54 (FIG. 2). In other words, the cluster module 30 determines the two respective module configurations for the two different vehicles 14 are combinable only when the differences are found in the remaining ECUs 42 between the two module configurations, and not the one or more target ECUs 42 and/or the one or more dependent ECUs 42. In response to determining no differences exist between the one or more target ECUs 42 and the one or more dependent ECUs 42 between the two respective module configurations, the cluster module 30 may then merge the two respective module configurations.

In one embodiment, the cluster module 30 merges the two respective module configurations together so that the module configuration having the highest overall vehicle volume exists after merging. Specifically, the cluster module 30 merges a first module configuration having a first overall volume with a second module configuration having a second overall volume so the second module configuration exists after merging, where the second overall volume is greater than the first overall volume. Once the cluster module 30 finishes combining together the module configurations for the group 16 of vehicles 14, the cluster module 30 may then establish a set of combined module configurations. The set of combined module configurations includes all of the module configurations for the group 16 of vehicles 14 that have been combined together.

The cluster module 30 sends the combined module configurations for the group 16 of vehicles 14 to the determination module 32. The determination module 32 selects one of the combined module configurations as the representative vehicle software configuration 12 based on at least one pre-defined criteria. The predefined criteria represent one or more of the following: a number of overall software components included by a combined module configuration, an overall volume of the combined module configuration, and a level of communication affected by the target ECUs 42 and the dependent ECUs 42. Specifically, the number of overall software components included by a combined module configuration indicates a total number of ECUs 42 and a total number of parts 54 of a specific vehicle 14. In one embodiment, the combined module configuration having the greatest number of overall software components is selected as the representative vehicle software configuration 12. In another embodiment, the combined module configuration having the highest overall volume is selected as the representative vehicle software configuration 12. The level of communication refers to a number of communication channels that are connected to each ECU 42 that is part of the combined module configuration, where a greater number of communication channels are given priority. The level of communication may also refer to a level of complexity of the communication channels as well. In this embodiment, higher levels of complexity are assigned to networking technologies such as an Ethernet connection, while lower levels of complexity are assigned to networking technologies such as a controller area network (CAN) bus.

In an embodiment, the cluster module 30 determines a virtual software configuration by combining two or more module configurations together based on a level of severity of the software update. Specifically, when the software update involves a bug fix or a periodic update, then the cluster module 30 determines the level of severity of the software update is low. In contrast, software updates that include new functionality or a network change, then the cluster module 30 determines the level of severity is high. In response to determining the level of severity of the software update is low, the cluster module 30 checks for compatibility of the software components 52 and, if applicable, considers one surrogate vehicle configuration. However, in response to determining the level of severity of the software update is high, the cluster module 30 considers the two or more module configurations separately.

In one embodiment, at least one of the combined module configurations is a virtual software configuration. A virtual software configuration is buildable, however, a virtual software configuration is not available in real life. In other words, the functionality of the virtual software configuration is possible, however, the representative vehicle software configuration 12 does not exist in the field. For example, it may be theoretically possible for a vehicle 14 to include one driver seat with a cloth exterior, and a passenger seat with a leather exterior. While it may be possible to build such a vehicle 14, this configuration is not found in real life.

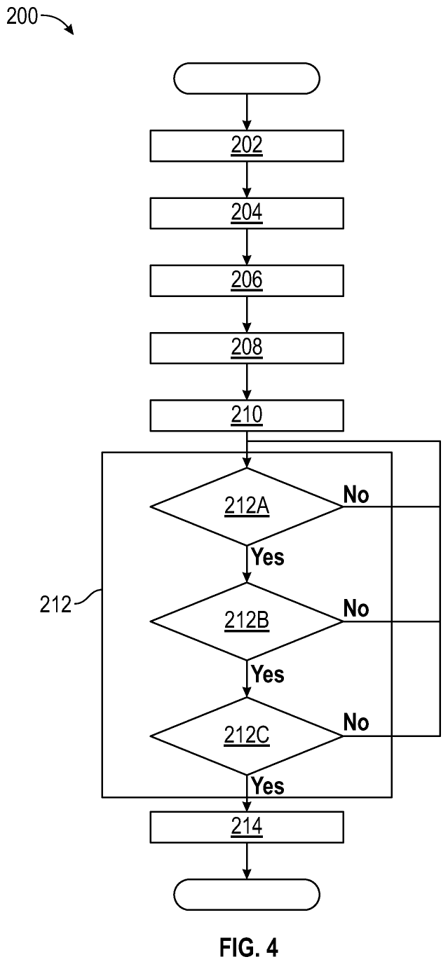

FIG. 4 is a process flow diagram illustrating a method 200 for determining the representative vehicle software configuration 12 for the subset 8 of vehicles 14. Referring generally to FIGS. 1-4, the method 200 may begin at block 202. In block 202, the identifier module 22 of the computing system 20 determines the one or more target ECUs 42 that the software update is applied to based on the field update details 60 for each vehicle 14 that is part of the group of vehicles 14. The method 200 may proceed to block 204.

In block 204, the target module 24 of the computing system 20 determines the set of dependent ECUs 42 for each vehicle 14 that is part of the group of vehicles 14 based on the one or more target ECUs 42 and the one or more system level configuration files 62. The method 200 may then proceed to block 206.

In block 206, the matrix building module 26 of the computing system 20 assigns a dependency level to each ECU 42 for each vehicle 14 that is part of the group of vehicles 14. The method 200 may proceed to block 206.

In block 208, the matrix building module 26 of the computing system 20 assigns, based on the dependency level, a respective weight value for each ECU 42 for each vehicle 14 that is part of the group of vehicles 14. The method 200 may then proceed to block 210.

In block 210, the distance module 28 of the computing system 20 determines a cluster distance 70 (FIG. 3) measured between two respective module configurations corresponding to two vehicles 14 that are part of the group of vehicles 14 based on the respective weight values assigned to the each of the ECUs 42 of the two vehicles 14. It is to be appreciated that the cluster distance 70 is determined between the module configurations for each vehicle 14 that is part of the group of vehicles 14. The method 200 may then proceed to block 212.

In block 212, the cluster module 30 of the computing system 20 combines two respective module configurations together with another based on the cluster distance 70 measured between the two vehicles 14 of the group of vehicles 14, the cluster distance threshold value 74, the set of merging constraints 76, and the set of mutually exclusive constraints 78. Specifically, in decision block 212A, the cluster module 30 compares the two respective module configurations with the set of mutually exclusive constraints 78 to confirm that the two respective module configurations are combinable. If the two respective module configurations are not combinable, then the two respective module configurations are not combinable, and the method 200 may return to block 212A to determine another combination. In response to confirming the two respective module configurations are combinable, the method 200 may proceed to decision block 212B.

In decision block 212B, the cluster module 30 compares the cluster distance 70 (shown in FIG. 3) measured between the two respective module configurations with the cluster distance threshold value 74. In response to determining the cluster distance 70 is less than the cluster distance threshold value 74, then the two respective module configurations are not combinable, and the method 200 may return to block 212A to determine another combination. In response to determining the cluster distance 70 is equal to or greater than the cluster distance threshold value 74, the method 200 may proceed to decision block 212C.

In decision block 212C, the cluster module 30 compares the two respective module configurations with one another to determine a difference in configuration for the two respective module configurations between the one or more target ECUs 42 and the one or more dependent ECUs 42. In response to determining differences exist between the one or more target ECUs and the one or more dependent ECUs for the two module configurations, the method 200 may return to block 212A to determine another combination. In response to determining no differences exist between the one or more target ECUs 42 and the one or more dependent ECUs 42 for the two module configurations, then the cluster module 30 merges the two respective module configurations together, and the method 200 proceeds to block 214.

In block 214, the determination module 32 selects one of the combined module configurations as the representative vehicle software configuration 12 based on at least one pre-defined criteria. The predefined criteria represent one or more of the following: a number of overall software components included by a combined module configuration, an overall volume of the combined module configuration, and a level of communication affected by the target ECUs 42 and the dependent ECUs 42. The method 200 may then terminate.

Referring generally to the figures, the disclosed system for determining the representative vehicle software configuration provides various technical effects and benefits. Specifically, the disclosed system provides a systematic, rules-based approach for determining the representative vehicle software configuration for a subset of vehicles that is part of a group of vehicles for a given software update. Determining a representative vehicle software configuration may be especially advantageous in situations where a vast number of different vehicle software configurations exist. Specifically, the representative vehicle software configuration is determined based on a hierarchical dependency structure between the ECUs for a specific vehicle, a clustering distance that is measured between two module configurations, and a rules-based logic to group the various module configurations into clusters.

The computing system may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the computing system may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for determining a representative vehicle software configuration for a subset vehicles that are part of a group of vehicles, the system comprising:
one or more processors; and
a memory coupled to the one or more processors, the memory storing data comprising a database and program code that, when executed by the one or more processors, causes the system to:
assign a dependency level to each electronic control unit (ECU) for each vehicle that is part of the group of vehicles;
assign, based on the dependency level, a respective weight value to each ECU for each vehicle that is part of the group;
determine a cluster distance measured between two respective module configurations corresponding to two vehicles that are part of the group based on respective weight values assigned to the each of the ECUs of the two vehicles, wherein the cluster distance is determined between the module configurations for each vehicle that is part of the group;
combine the two respective module configurations together with another based on at least the cluster distance measured between the two respective module configurations to establish a set of combined module configurations; and
select a module configuration that is part of the set of combined module configurations as the representative vehicle software configuration based on at least one predefined criteria.

2. The system of claim 1, wherein the one or more processors execute instructions to:
determine one or more target ECUs that a software update is applied to based on field update details for each vehicle that is part of the group of vehicles.

3. The system of claim 2, wherein the one or more processors execute instructions to:
determine one or more dependent ECUs based on the one or more target ECUs and one or more system level configuration files, wherein the system level configuration files indicate the one or more dependent ECUs that are affected by the software update applied to the one or more target ECUs.

4. The system of claim 3, wherein the respective weight value ranges from zero to one, wherein a highest respective weight value is assigned to the one or more target ECUs, and lower respective weight values are assigned to the one or more dependent ECUs.

5. The system of claim 3, wherein the one or more processors execute instructions to:
adjust the respective weight value assigned to a specific ECU based on a type of change that the software update introduces to the one or more target ECUs, wherein the type of change that the software update introduces is selected from one of the following: a data type change, a value range change, and a calculation logic change.

6. The system of claim 5, wherein the one or more processors execute instructions to:
in response to determining the type of change that the software update introduces is either the data type change or a value range change, adjust the respective weight value to a highest value assigned to a range of respective weight values.

7. The system of claim 5, wherein the one or more processors execute instructions to:
in response to determining the type of change the software update introduces is a calculation logic change, adjust the respective weight value to a lowest value assigned to a range of respective weight values.

8. The system of claim 3, wherein a module configuration indicates a number of total ECUs for a particular vehicle, a number of target ECUs for the particular vehicle, and a number of dependent ECUs for the particular vehicle.

9. The system of claim 8, wherein the cluster distance between the two respective module configurations is calculated based on:
cluster distance(configi,configj)=(w1*TEC_{i∩j})+(w2*DEC_{i∩j})+(w3*REC_{i∩j})/(w1*TEC_{i∪j})+(w2*DEC_{i∪j})+(w3*REC_{i∪j})
wherein TEC represents the number of target ECUs for the particular vehicle, DEC represents the number of dependent ECUs for the particular vehicle, REC represents a number of remaining ECUs for the particular vehicle, i and j represent the two vehicles, w1 is the respective weight value assigned to the one or more target ECUs, w2 is the respective weight value assigned to the set of dependent ECUs, and w3 is the respective weight assigned to the remaining ECUs.

10. The system of claim 3, wherein combining at least two of the respective module configurations together with another comprises:
comparing the two respective module configurations with a set of mutually exclusive constraints to confirm that the two respective module configurations are combinable; and
in response to confirming the two respective module configurations are combinable, comparing the cluster distance measured between the two respective module configurations with a cluster distance threshold value.

11. The system of claim 10, wherein combining at least two of the module configurations together with another comprises:
in response to determining the cluster distance is equal to or greater than the cluster distance threshold value, comparing the two respective module configurations with one another to determine a difference in configuration for the two respective module configurations between the one or more target ECUs and the one or more dependent ECUs; and
in response to determining no differences exist between the one or more target ECUs and the one or more dependent ECUs between the two module configurations, merge the two respective module configurations together.

12. The system of claim 3, wherein the respective weight values range from zero to one.

13. The system of claim 3, wherein a highest respective weight value is assigned to the one or more target ECUs and a lower respective weight value is assigned to the one or more dependent ECUs.

14. The system of claim 1, wherein the predefined criteria represent one or more of the following: a number of overall software components included by a combined module configuration, an overall volume of the combined module configuration, and a level of communication affected by the one or more target ECUs and the dependent ECUs.

15. A system for determining a representative vehicle software configuration for a subset vehicles that are part of a group of vehicles, the system comprising:
one or more processors; and
a memory coupled to the one or more processors, the memory storing data comprising a database and program code that, when executed by the one or more processors, causes the system to:
determine one or more target ECUs that a software update is applied to based on field update details for each vehicle that is part of the group of vehicles;
determine one or more dependent ECUs based on the one or more target ECUs and one or more system level configuration files, wherein the system level configuration files indicate the one or more dependent ECUs that are affected by the software update applied to the one or more target ECUs;
assign a dependency level to each ECU for each vehicle that is part of the group of vehicles;
assign, based on the dependency level, a respective weight value to each ECU for each vehicle that is part of the group, wherein a highest respective weight value is assigned to the one or more target ECUs, and lower respective weight values are assigned to the one or more dependent ECUs;
determine a cluster distance measured between two respective module configurations corresponding to two vehicles that are part of the group based on respective weight values assigned to the each of the ECUs of the two vehicles, wherein the cluster distance is determined between the respective module configurations for each vehicle that is part of the group;
combine the two respective module configurations together with another based on at least the cluster distance measured between the two respective module configurations to establish a set of combined module configurations; and
select a module configuration that is part of the set of combined module configurations as the representative vehicle software configuration based on at least one predefined criteria.

16. The system of claim 15, wherein the one or more processors execute instructions to:
adjust the respective weight value assigned to a specific ECU based on a type of change that the software update introduces to the one or more target ECUs, wherein the type of change that the software update introduces is selected from one of the following: a data type change, a value range change, and a calculation logic change.

17. The system of claim 16, wherein the one or more processors execute instructions to:
in response to determining the type of change that the software update introduces is either the data type change or a value range change, adjust the respective weight value to a highest value assigned to a range of respective weight values.

18. The system of claim 16, wherein the one or more processors execute instructions to:
in response to determining the type of change the software update introduces is a calculation logic change, adjust the respective weight value to a lowest value assigned to a range of respective weight values.

19. The system of claim 15, wherein the module configuration indicates a number of total ECUs for a particular vehicle, a number of target ECUs for the particular vehicle, and a number of dependent ECUs for the particular vehicle.

20. A method for determining a representative vehicle software configuration for a subset vehicles that are part of a group of vehicles, the method comprising:
assigning, by a computing device, a dependency level to each electronic control unit (ECU) for each vehicle that is part of the group of vehicles;
assigning based on the dependency level, a respective weight value to each ECU for each vehicle that is part of the group;
determining a cluster distance measured between two respective module configurations corresponding to two vehicles that are part of the group based on respective weight values assigned to the each of the ECUs of the two vehicles, wherein the cluster distance is determined between the two respective module configurations for each vehicle that is part of the group;
combining, by the computing device, the two respective module configurations together with another based on at least the cluster distance measured between the two respective module configurations to establish a set of combined module configurations; and
selecting one of the module configurations that are part of the set of combined module configurations as the representative vehicle software configuration based on at least one predefined criteria.
